(19) United States
(12) Patent Application Publication
(10) Pub. No.: US 2010/0102733 A1
(43) Pub. Date: Apr. 29, 2010

(54) LED LIGHT STRING

(76) Inventor: Chen-Sheng YANG, Kaohsiung (TW)

Correspondence Address: RABIN & Berdo, PC, 1101 14TH STREET, NW, SUITE 500, WASHINGTON, DC, 20005, US

(21) Appl. No.: 12/259,477

(22) Filed: Oct. 28, 2008

(51) Int. Cl. H05B 37/00

(52) U.S. Cl. 315/185 R

(57) ABSTRACT

A light emitting diode light string has a front plug, a rear socket and an LED assembly. The front plug has a first end, a second end and a resistor being mounted inside the front plug and connected to the first end. The rear socket has a first end and a second end. The LED assembly is electrically connected between the resistor and the second end of the rear socket and has multiple LEDs being connected in serial. Plastic package materials for sealing resistors are unnecessary. Therefore cost of manufacturing the LED light string is low.

### BACKGROUND OF THE INVENTION

1. Field of the Invention

The present invention relates to an LED light string, especially to an LED light string that saves cost of package materials of current-limiting resistors.

2. Description of the Related Art

With reference to FIGS. 3 and 4, a conventional light-emitting diode (LED) light string comprises a front plug (40), a rear socket (41), two resistor devices (42) and an LED assembly (43). One of the resistor devices (42) is connected to an end of the front plug (40) and the other one of the resistor devices (42) is connected to an end of the rear socket (41). The LED assembly (43) is connected between the resistor devices (42) and comprises multiple LEDs connected in series. The resistor devices (42) limit electric current to safe values from overheating and damaging the LEDs.

Usually foregoing resistor devices (42) are plastic-sealed by a plastic injection molding machine after being electrically connected to the front plug (40), the rear socket (41) and the LED assembly (43) via wire bonding. Therefore plastic package materials, such as epoxy molding compound, are required and cost of manufacturing the conventional LED light string is accordingly increased. Furthermore, the appearance of the conventional LED light string is unsightly due to the resistor devices (42).

To overcome the shortcomings, the present invention provides an LED light string to mitigate or obviate the aforementioned problems.

### SUMMARY OF THE INVENTION

The main objective of the invention is to provide an LED light string that saves cost of package materials of current-limiting resistors.

The light emitting diode (hereafter LED) light string in accordance with the present invention comprises a front plug, a rear socket and an LED assembly.

The front plug has a first end, a second end and a resistor being mounted inside the front plug and connected to the first end. The rear socket has a first end and a second end. The LED assembly is electrically connected between the resistor and the second end of the rear socket and has multiple LEDs being connected in serial.

Plastic package materials for sealing resistors are saved. Therefore cost of manufacturing the LED light string is low.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of an LED light string in accordance with the present invention;

FIG. 2 is an equivalent circuit diagram of an LED light string of the present invention;

FIG. 3 is a perspective view of a conventional LED light string; and

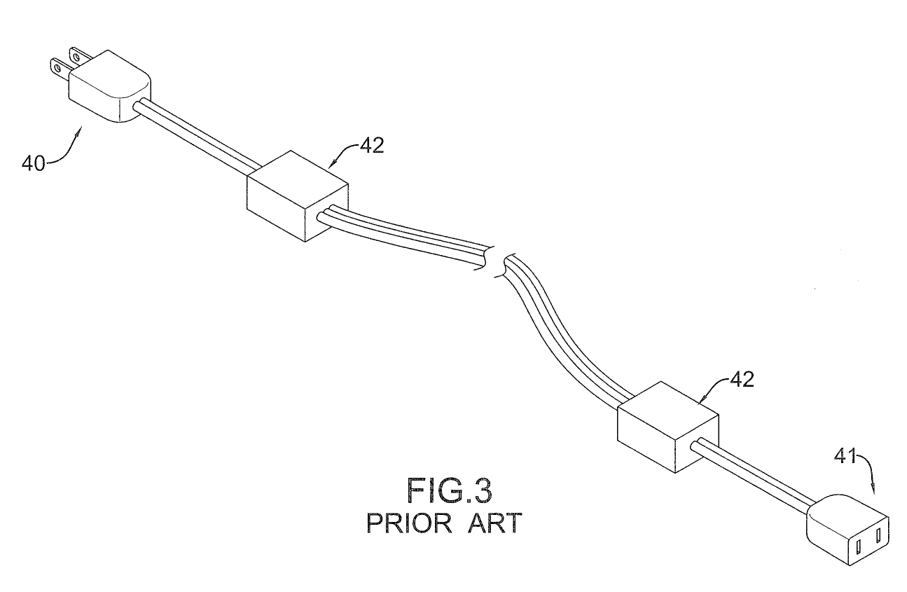

FIG. 4 is circuit diagram of the conventional light string in FIG. 3.

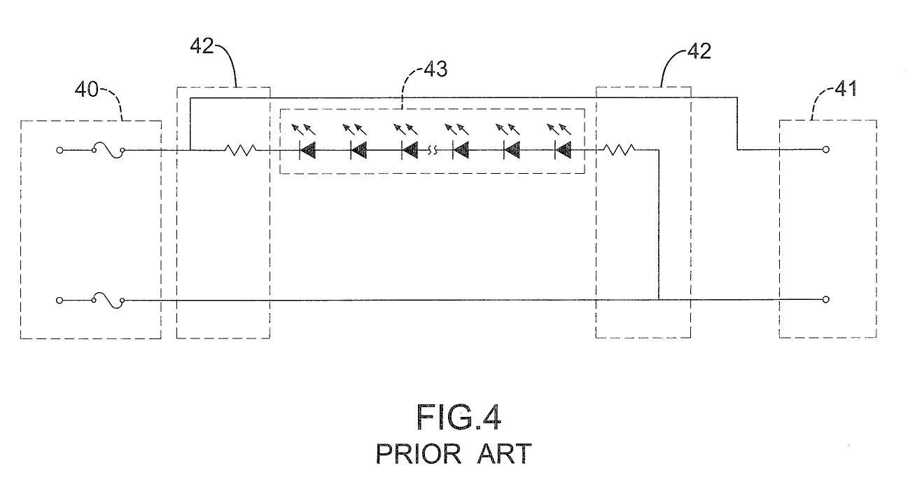

### DETAILED DESCRIPTION OF THE PREFERRED EMBODIMENTS

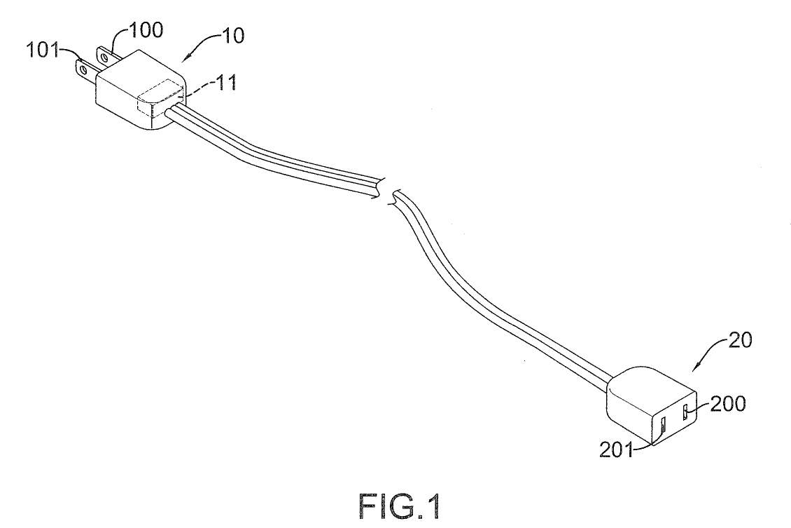

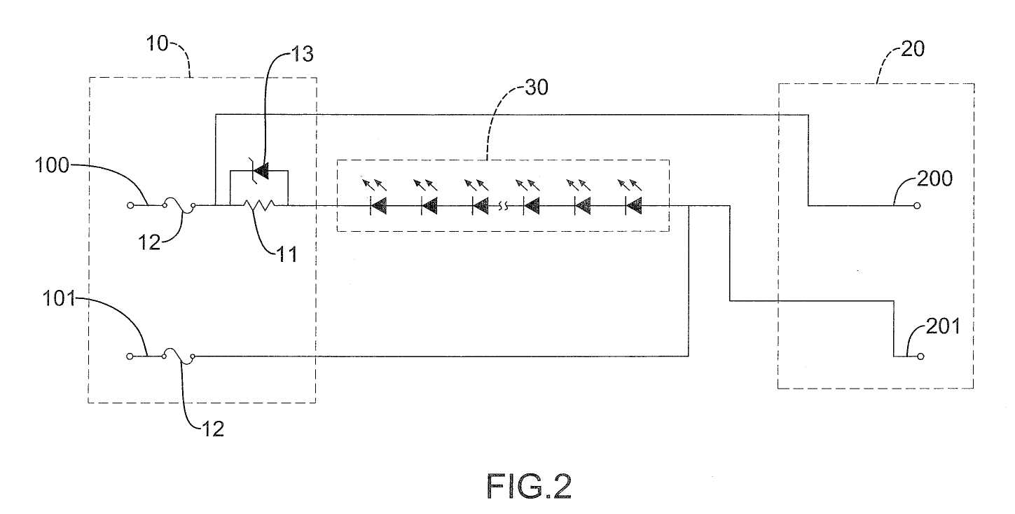

With reference to FIGS. 1 and 2, a light emitting diode (LED) light string in accordance with the present invention comprises a front plug (10), a rear socket (20) and an LED assembly (30).

The front plug (10) has a first end (100), a second end (101) and a resistor (11) and may have two fuses (12) and a Zener diode (13) and may be adapted to receive an AC power source. The resistor (11) is mounted inside the front plug (10) and connected to the first end (100). The fuses (12) are respectively coupled to the first and the second ends (100, 101). The Zener diode (13) is connected to the resistor (11) in parallel.

The rear socket (20) has a first end (200) and a second end (20 1) and may be adapted to connect to a front plug (10) of another same LED light string.

The LED assembly (30) is electrically connected between the resistor (11) and the rear socket (20) and comprises multiple LEDs being connected in series.

The fuses (12) of the front plug (10) may melt for protecting other components from damage when one of the LEDs of the LED assembly (30) fails and causes a short circuit. The Zener diodes (12) is used to maintain a constant voltage in the event of over-voltage and protects the LED light string from damage. Therefore the LED light string of the present invention is safe.

The resistor (11) and the Zener diode (13) can be mounted in the front plug (10) or the rear socket (20). Therefore, in another embodiment of the present invention, the resistor (11) is mounted inside the rear socket (20) and connected to the second end (201) of the rear socket, and the Zener diode(13) is connected to the resistor (11) in parallel.

Since the front plug (10) or the rear socket (20) has a built-in resistor, plastic package materials for sealing resistors are unnecessary. Therefore cost of manufacturing the LED light string of the present invention is lower than manufacturing conventional ones. Besides, without the plastic-sealed resistor device, the appearance of the LED light string maintains sightly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED light string comprising:
a front plug having
a first end;
a second end; and
a resistor being mounted inside the front plug and connected to the first end;
a rear socket having a first end and a second end; and
an LED assembly being electrically connected between the resistor and the first end of the rear socket and having multiple LEDs being connected in series.

2. The LED light string as claimed in claim 1, wherein the front plug further has
two fuses being respectively coupled to the first and the second ends of the front plug; and
a Zener diode being connected to the resistor of the front plug in parallel.
